(19) United States
(12) Patent Application Publication
(10) Pub. No.: US 2015/0020770 A1
(43) Pub. Date: Jan. 22, 2015

(54) FUEL MIXTURE SYSTEM AND ASSEMBLY

(71) Applicant: Jason Green, Davie, FL (US)

(72) Inventor: Jason Green, Davie, FL (US)

(21) Appl. No.: 13/947,410

(22) Filed: Jul. 22, 2013

(51) Int. Cl. F02D 41/00

(52) U.S. Cl. CPC F02D 41/00
USPC 123/344

(57) ABSTRACT

A system and attendant structural assembly operative to establish a coordinated mixture of gaseous and distillate fuels for an engine including an electronic control unit (ECU) operative to monitor predetermined engine data determinative of engine fuel requirements and structured to regulate ratios of the gaseous and distillate fuel of an operative fuel mixture for the engine. The system and assembly includes at least one mixing assembly comprising an integrated throttle body and air gas mixer directly connected to one another, wherein the throttle body is disposed in fluid communication with a pressurized gaseous fuel supply and the air gas mixer is disposed in fluid communication with a flow of intake air to a combustion section of the engine. In use, the throttle body is structured to direct a variable gaseous fuel flow directly to the air gas mixer for dispensing into the intake air flow to the combustion section.

### BACKGROUND OF THE INVENTION

1. Field of the Invention

This invention is directed to a system and attendant apparatus operative to establish a variable operative fuel mixture for powering a stationary engine or generator as well, as a vehicle engine. The operative fuel mixture may comprise a varying ratio of both a gaseous fuel, such as natural gas, and a distillate fuel, such as diesel. The ratio of gaseous and distillate fuel is dependent, at least in part, on a plurality of operating characteristics of the engine, which are monitored by an electronic control unit (ECU). The system is adaptable for determining an efficient and effective operative fuel mixture due at least partially to the inclusion of one or more mixing assemblies each comprising and integrated throttle body and air-gas mixer.

2. Description of the Related Art

Typically large, stationary engines as well as mobile engines used to power heavy duty industrial vehicles are powered by either direct drive diesel or diesel electric power trains frequently including a multiple horse power turbo charged operation.

Accordingly, it is well recognized that distillate fuels, specifically diesel, are used as the primary fuel source for such engines. Attempts to maximize the operational efficiency, while maintaining reasonable safety standards, have previously involved modified throttle control facilities. These attempts serve to diminish adverse effects of control mechanisms which may be potentially harmful to the engine operation and may also be at least generally uneconomical. Typical adverse effects include increased fuel consumption and wear on operative components. Therefore, many diesel engines are expected to accommodate various types of high capacity loads and provide maximum power for relatively significant periods of operation. As a result, many diesel engines are commonly operated at maximum or near maximum capacity resulting in an attempted maximum power delivery from the engine and consequent high rates of diesel consumption. It is generally recognized that the provision of a substantially rich fuel mixture in the cylinders of a diesel engine is necessary for providing maximum power when required. Such continued high capacity operation of the engine results not only in wear on the engine components, but also in high fuel consumption rates, lower operating efficiencies, more frequent oil changes and higher costs of operation.

Accordingly, there is a long recognized need for a fuel control system specifically intended for use with high capacity, variable or constant speed compression ignition engines that would allow the use of more efficient fueling methods using other commonly available fuel sources. Therefore, an improved fuel control system is proposed which is determinative of an effective and efficient operative fuel mixture comprised of a combination of gaseous and distillate fuels. More specifically, gaseous fuels can comprise a natural gas or other appropriate gaseous type fuels, wherein distillate fuel would typically include, but not be limited to diesel fuel.

Such a preferred and proposed fuel control system should be capable of regulating the composition of the operative fuel mixture on which the engine operates to include 100% distillate fuel, when the operating mode(s) thereof clearly indicate that the combination of gaseous and distillate fuels is not advantageous. Further, such a proposed fuel control system could have an included secondary function to act as a general safety system serving to monitor critical engine operating parameters. As a result, control facilities associated with such a preferred fuel control system should allow for discrete, user defined control and safety set points for various engine and/or fuel system parameters.

### SUMMARY OF THE INVENTION

This invention is directed to a system and included apparatus, comprising technology that allows for the safe and efficient use of a gaseous fuel such as, but not limited to, natural gas, in combination with a predetermined quantity of conventional distillate fuel, such as diesel fuel. As a result, the composition of an “operative fuel mixture” used to power an associated engine will, dependent on the operating modes and/or operating characteristics thereof, be either a combined mixture of gaseous fuel and distillate fuel or substantially entirely distillate fuel, absent any contribution of gaseous fuel.

Moreover, the fuel control system of the present invention incorporates “real time” measurement capabilities specifically, but not exclusively, of each of the gaseous fuel and distillate fuel and the operative fuel mixture. More specifically, metering technology appropriate to each of the gaseous and distillate fuels will be used to establish the percentage of gaseous fuel and diesel fuel contained in the composition of the operative fuel mixture. Such appropriate metering will also facilitate the tracking of the overall gaseous fuel and diesel fuel consumption.

Accordingly, the system of at least one preferred embodiment of the present invention includes both controlling and safety features, specifically adaptable for use with compression ignition engines (CI), of the type more fully described herein. It is to be noted that the term “operative fuel mixture” may, as set forth above, include a composition composed of both gaseous fuel and distillate fuel present in varying ratios. However, for purposes of clarity, the term “operative fuel mixture” may also specifically refer to a composition comprised substantially entirely of the distillate fuel. Therefore, and as set forth in greater detail hereinafter, the composition of the operative fuel mixture may best comprise both gaseous fuel and distillate fuel in predetermined quantities, wherein the ratio of the gaseous and distillate fuels may vary. It is again emphasized, that the term “gaseous fuel” is meant to include natural gas or other gaseous type fuels appropriate for engine operation. Similarly, the term “distillate fuel” refers primarily, but not exclusively, to a diesel fuel.

The system and assembly of the present invention allows operators of stationary engines, including electric power generators and/or vehicle mounted engines, to substantially reduce costs, extend run time and improve sustainability by substituting natural gas or other gaseous fuel for a portion of the distillate fuel, such as diesel fuel in predetermined ratios. As a result, safe use of a natural gas and other gaseous fuel is used in place of distillate fuel with the combined ratios of an “operative gas mixture” in the range of 50% to 70% of the engines total fuel requirement. Importantly, generators or other stationary engines converted with the system and assembly of the present invention exhibit diesel like performance in such critical areas as load acceptance, power output, stability and efficiency.

Additional advantages of the system and assembly of the present invention allow for the onsite conversion of stationary or mobile engines to natural gas and/or diesel fuel operation. The installation and/or conversion process utilizes components that are installed externally of the engine/generator in a manner which does not require any changes or modifications to the combustion section thereof. As such, OEM combustion section components including cylinders, pistons, fuel injectors and/or cylinder heads remain the same. By retaining the OEM diesel or distillate fuel system in its entirety, the operative and structural features of the present invention maintains the engines capability to operate solely on diesel fuel when such is needed based on the operational modes or operating characteristics of the engine.

Moreover, the present invention utilizes “pipe-line supplied gaseous fuel” at a positive pressure, generally in the range of 3 psi to 7 psi. Accordingly, gaseous fuel is added to the intake air of the combustion section of the engine, at a positive pressure, utilizing one or more unique mixing assemblies. In more specific terms, each of the one or more mixing assemblies includes an electronically controlled throttle body integrated with a fixed geometry, low restriction air gas mixture. In terms of the integrated features of the throttle body and corresponding air gas mixer, the air gas mixer comprises a housing wherein the throttle body is fixedly mounted on or connected directly to the housing of the corresponding air gas mixer, such as on the exterior thereof. In addition, at least a portion of the housing of the air gas mixer is disposed in and thereby may at least partially define a path of travel or flow line of intake air to the combustion section of the engine. Moreover, a dispensing nozzle is disposed within the interior of the housing in direct communication and/or aligned relation within the flow path of the intake air. Further, a delivery conduit is disposed on the interior of the housing of the air gas mixer in interconnecting, gaseous fuel delivering relation between the throttle body and the dispensing nozzle.

As indicated, the supply of gaseous fuel is maintained at a positive pressure and delivered from the fuel supply to the throttle body and eventually from the throttle body to the corresponding, integrated air gas mixer at such positive pressure. Therefore, the gaseous fuel supply, throttle body and integrated air gas mixer are cooperatively structured and collectively operative to deliver gaseous fuel in appropriate, variable quantities and under a positive pressure to the intake air of the combustion section of the engine. This may differ from conventional fuel systems, wherein fuel is not maintained under a positive pressure or “pushed” from a fuel delivery assembly into the flow path of intake air. Moreover, one advantageous feature of the positive pressure delivery of the gaseous fuel of the present invention comprises the ability to “predict” and/or more precisely control the quantity of gaseous fuel being delivered to the flow of intake air and to the combustion section of the engine. As a result the maximum amount of gaseous fuel, within predetermined limits or parameters, may be added to the gaseous and distillate fuel mixture of the operative fuel composition and thereby assure efficient operation of the engine without consuming an excessive amount of distillate fuel. Factors which may limit the delivery of the maximum quantity of gaseous fuel, as set forth above may include, but are not limited to, the occurrence of “knocking” in the engine, maintaining appropriate lower flammability limits, etc.

Further direct mounting or connection of the throttle body to the integrated air gas mixer provides an additional safety feature. More specifically, due to such an integrated structure, there will not be a collection of gaseous fuel in a connecting conduit or line, between throttle body and air gas mixer and/or intake air, which may exist in conventional fuel systems. Therefore, unlike conventional fuel delivery connections, the gaseous fuel of the present invention may be “pushed” under the aforementioned positive pressure from the throttle body directly into the air gas mixer.

Dependent on the structural and operative features of the engine and/or generator with which the system and included structure is utilized, a turbo charger may be disposed within one or more intake air flow paths to the combustion chamber. When one or more turbochargers are so utilized and installed, the integrated throttle body and air gas mixer are disposed in fluid communication with the corresponding flow path upstream of the turbocharger. In yet another preferred embodiment of the system and assembly of the present invention a plurality of mixing assemblies are utilized, wherein each mixing assembly comprises an integrated throttle body and air gas mixer. As set forth above, the structural integration of each of the throttle body and corresponding air gas mixer comprises the air gas mixer including a housing disposed at least partially within and thereby at least partially defining the intake air flow path to the combustion section of the engine. Further, each throttle body will be fixedly mounted on or directly connected to the corresponding, integrated air gas mixer, such as on the housing thereof, to at least partially define the integrated structure thereof. The result of this integrated structure will be the advantages and enhanced operative features, as set forth above.

As also indicated, each of the throttle bodies are independently operable based on monitored data determined by the ECU. As a result, each of a plurality of integrated throttle bodies/air gas mixers may provide a different and variable gaseous fuel flow to a different intake air flow path and corresponding combustion cylinder of the combustion section of the engine. Therefore, each combustion cylinder associated with the engine/generator with which the system of the present invention is utilized, may receive a gaseous fuel and distillate fuel mixture which differs from one or more of the other cylinders, depending upon the operating characteristics of the engine. This allows for even greater efficiency in regulating output of the engine based on operating characteristics of the engine, as detected by the monitoring capabilities of the ECU. Such engine operating characteristics include, but are not limited to, fuel rates, exhaust gas temperatures, vibrations levels, manifold air temperatures, mass air flow, gas pressures, engine coolant temperature, engine RPM, compressor inlet pressures and/or manifold air pressures. Operational enhancement and versatility of the ECU is structured to sample each data input up to 50 times per second thereby insuring rapid detection and collection of anomalies.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of one preferred embodiment of the system and assembly of the present invention wherein a mixing assembly comprising an integrated throttle body and air gas mixer are connected to an intake air flow path being delivered to a combustion section of an engine/generator with which the mixing assembly is utilized.

FIG. 2 is a schematic representation of the embodiment of FIG. 1.

FIG. 3 is a schematic representation of yet another preferred embodiment of the system of the present invention comprising a plurality of mixing assemblies of the type represented in FIGS. 1, 4 and 5.

FIG. 4 is a perspective detailed view of an integrated throttle body and air gas mixer defining one of a possible plurality of mixing assemblies of the type represented in FIG. 1.

FIG. 5 is a rear perspective detailed view of the embodiment of FIG. 4.

Like reference numerals refer to like parts throughout the several views of the drawings.

### DETAILED DESCRIPTION OF THE PREFERRED EMBODIMENT

As schematically represented in the accompanying Figures, the present invention is directed to a control system and included structure operative to establish a coordinated operative fuel mixture of combined gaseous fuel and distillate fuel. The ratio of gaseous fuel to distillate fuel will vary dependent on the operating characteristics of an engine which incorporates the structural and operative features of the system of the present invention. In particular, the control system of the present invention is specifically, but not exclusively, adaptable for use with stationary compression ignition (CI) engines or generators, which may or may not include turbo-charging capabilities.

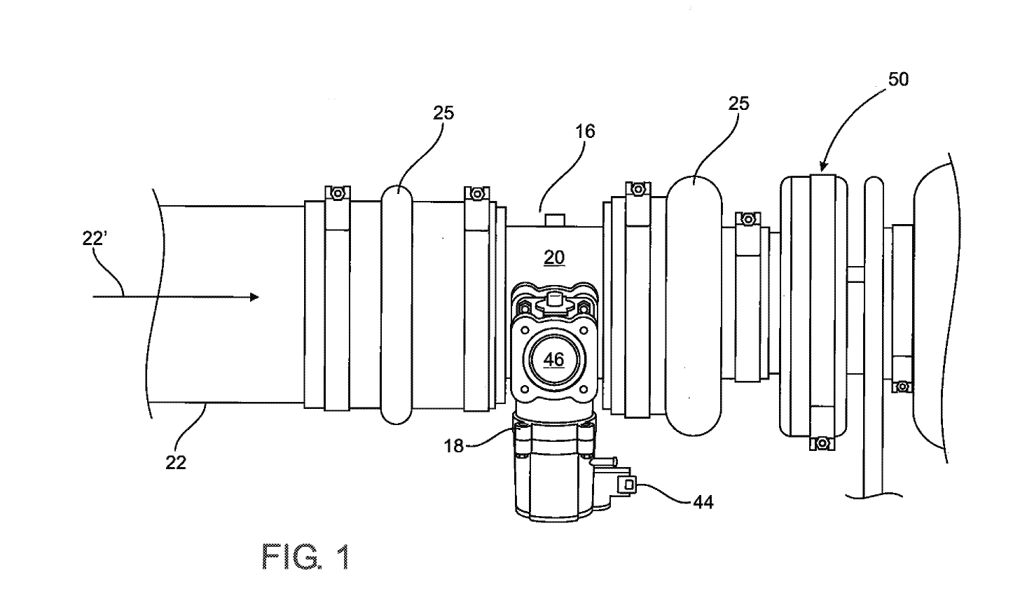

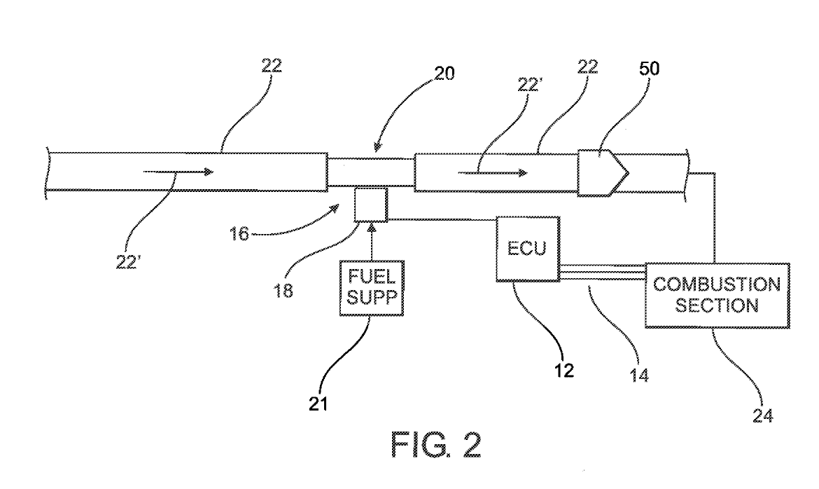

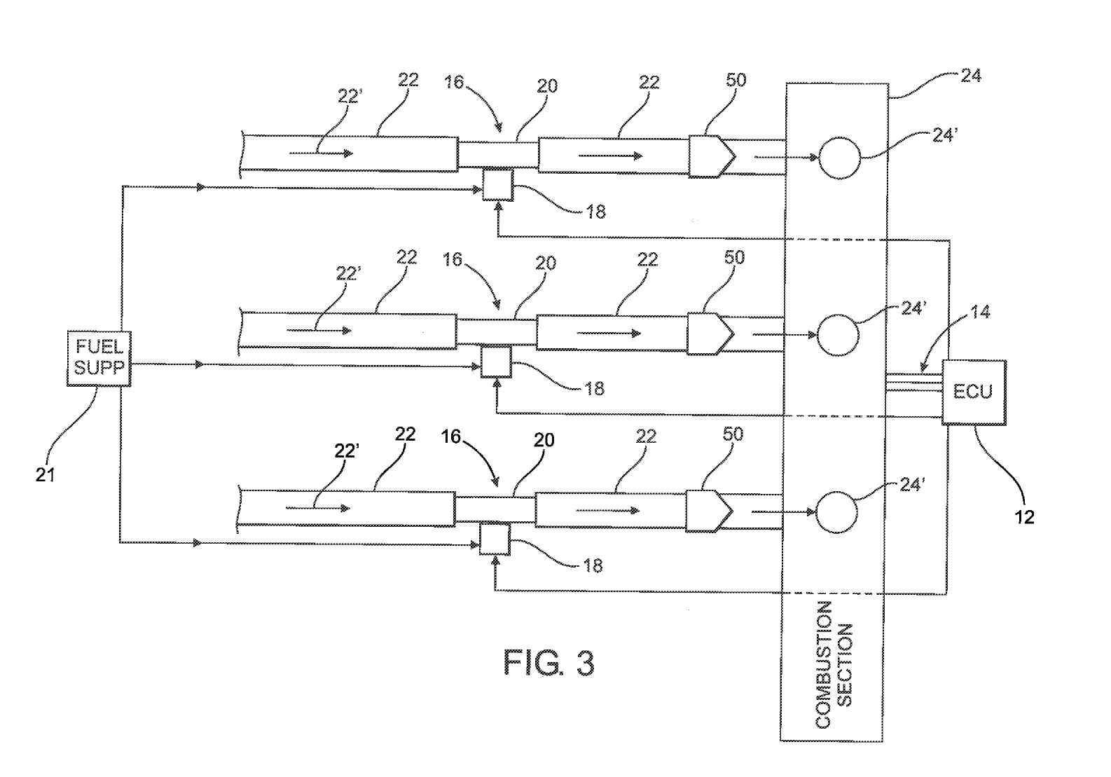

With primary references to FIGS. 1-3, the system of the present invention comprises an electronic control unit 12 operative to monitor at least predetermined engine data associated with and indicative of the operating characteristics of the engine with which the system is utilized. It is emphasized that FIGS. 2 and 3 are schematic representations intended to provide a detailed description of the structural and operative characteristics of the system of the present invention. As such, the electronic control unit (ECU) 12 includes a plurality of data channels 14 for the monitoring of intended, predetermined or critical parameters such as, but not necessarily limited to fuel rates, exhaust gas temperatures, operation levels, manifold air temperatures, mass air flow, gas pressure, engine coolant, engine RPM, compressor inlet pressures and manifold air pressures, etc.

In addition, one feature of the system of the present invention is the incorporation of at least one mixing assembly generally indicated as 16. As also schematically represented in FIG. 3, yet another preferred embodiment of the system of the present invention incorporates the use of a plurality of such mixing assemblies 16 as will be described in greater detail hereinafter. Accordingly, each mixing assembly 16 comprises an integrated throttle body 18 and air gas mixer 20. Each of the one or more throttle bodies 18 is connected in fluid communication with a gaseous fuel supply 22. Moreover, each of the air gas mixers 20, being structurally integrated with a corresponding one of throttle bodies 18, is disposed in direct fluid communication with a flow path 22 of intake air 22′, wherein the flow path or flow line 22 may be an OEM portion of the engine, as represented in FIG. 1, so as to deliver intake air 22′ to a combustion section 24 of the engine.

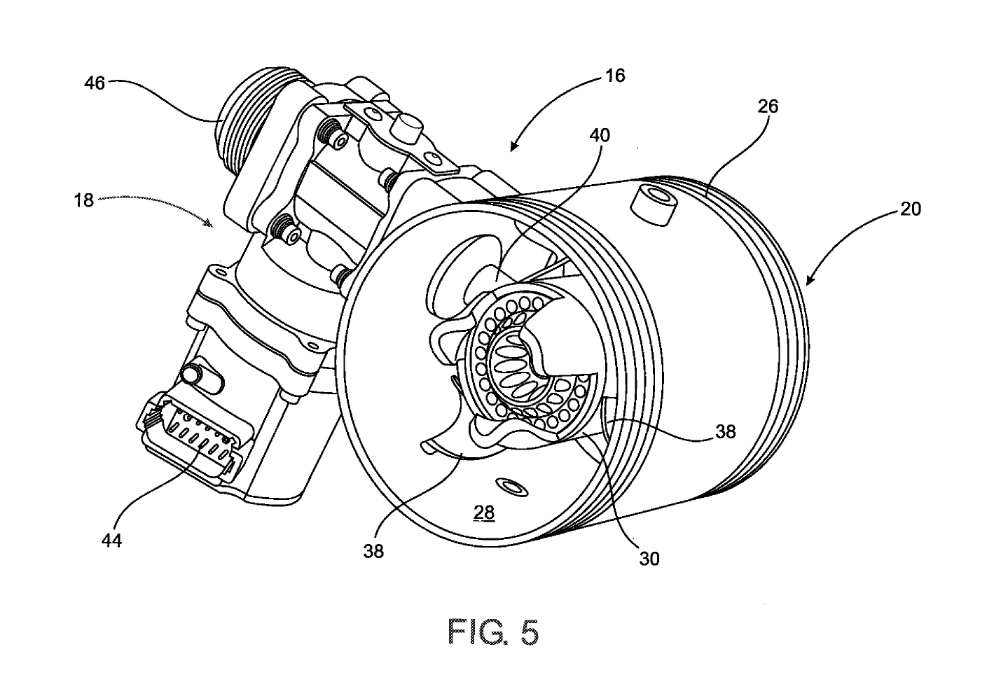

With primary reference to FIGS. 1, 4 and 5 each of the one or more mixing assemblies 16 is defined by the structurally integrated throttle body 18 and air gas mixer 20. As such, the air gas mixer 20 includes a housing 26 having an interior 28 which at least partially defines a corresponding one of the flow paths 22 of the inlet air 22′ being delivered to the combustion section 24. As clearly represented in FIG. 1, the housing 26 of the air gas mixer 20 may be installed directly in-line with the corresponding OEM air intake flow path 22, by any appropriate fluid seal connectors, as at 25, Such installation thereby facilitates the interior 28 of the housing 26 defining at least a portion of the flow path 22 of the intake air 22′.

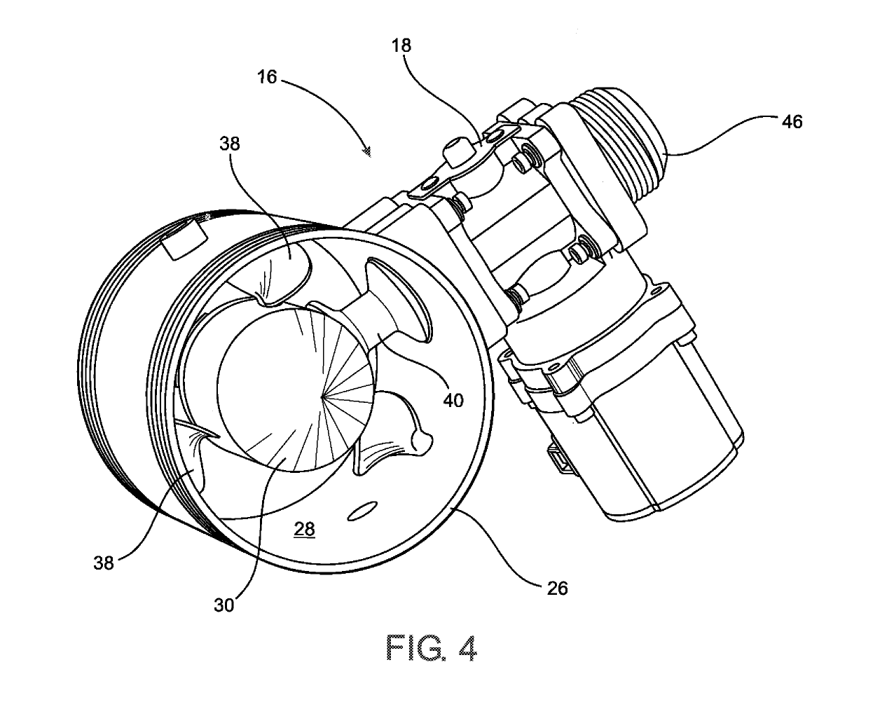

Additional structural features of the air mixer 20 include a dispensing nozzle 30 represented in FIGS. 3 and 4. The dispensing nozzle 30 includes an aerodynamically shaped head 31 formed on one end of the nozzle 30. A plurality of dispensing nozzle ports 32, represented in FIG. 4, are disposed downstream of the head 31 and are structured to deliver or dispense the gaseous fuel, received from the corresponding, integrated air mixer 20, directly into the intake air 22′ travelling along the intake air flow path 22 as set forth above. At least one, but preferably a plurality of interconnecting segments or vanes 34, are disposed and structured to facilitate the substantially aligned, supported disposition of the dispensing nozzles 30 into the flow path 22 of intake air 22′. Further, each of the connecting vanes 38 may be configured and dimensioned to not adversely disrupt air flow 22′ and further facilitate proper mixing of the gaseous fuel into the flow of intake air 22′. A delivery conduit 40 is also disposed on the interior of the housing 26 and serves to provide a direct fluid flow connection of gaseous fuel from the throttle housing 18 into the delivery nozzle 30 of the corresponding, integrated air gas mixer 20.

In at least one preferred embodiment, the structural integration of the throttle body 18 and air gas mixer 20 comprises the mounting and/or direct fixed connection of the throttle body 18 on the exterior of the housing 26. Therefore, the delivery conduit 40 is in direct fluid communication between the nozzle 30 and the outlet fuel outlet (not shown) from the throttle body 18. Due to such an integrated structure, there will not be a collection of gaseous fuel in a connecting conduit or line, between throttle body and air gas mixer and/or intake air, which may exist in conventional fuel systems. Therefore, unlike conventional fuel delivery connections, the gaseous fuel of the present invention may be “pushed” under positive pressure from the throttle body 18 directly into the air gas mixer 20.

More specifically, and as indicated herein, the gaseous fuel supply 21 stores, maintains and dispenses the gaseous fuel under a positive pressure to the throttle body 18. As a result, there will be a positive pressure flow of gaseous fuel, through the delivery conduit 40, into the dispensing nozzle 30. Due to this positively pressurized fuel delivery, there will be no collection of gaseous fuel between the throttle body 18 and the dispensing nozzle 30 of the air gas mixer 20 as may be known in conventional fuel systems as at least generally set forth above. Therefore, the supply of gaseous fuel is maintained at a positive pressure and delivered from the fuel supply 21 to the throttle body 18 and eventually from the throttle body 18 to the corresponding, integrated air gas mixer 20 at such positive pressure. Accordingly, the gaseous fuel supply 21, throttle body 18 and integrated air gas mixer 20 are cooperatively structured and collectively operative to deliver gaseous fuel in appropriate, variable quantities and under a positive pressure to the intake air 22′ of the combustion section 24 of the engine.

In the embodiments of FIGS. 1, 4 and 5, the throttle body 18 is electrically powered and as such includes an electrical socket or other appropriate connection 44. Further, the delivery of gaseous fuel from the fuel supply 21, under pressure, to the throttle body 18 is accomplished by interconnection of an appropriate conduit or line to a throttle body inlet 46.

With primary reference to FIG. 3 in combination with the structural details represented in FIGS. 1, 4 and 5, an additional preferred embodiment of the system comprises the electronic control unit structured to monitor predetermined engine data by virtue of at least one but more practically a plurality of data input and input channels 14. As indicated, the monitored engine data is determinative of engine fuel requirements and will ultimately determine the appropriate and/or most efficient ratio between the distillate fuel and gaseous fuel defining the aforementioned operative fuel mixture being delivered to the combustion section 24 and/or the individual combustion cylinders 24′ defining the combustion section 24. As with the embodiment of FIG. 2, additional preferred embodiment includes a pressurized gaseous fuel supply 21 structured to retain and dispense the gaseous fuel under a positive pressure preferably, but not necessarily, of generally about 3 psi to 7 psi. As also emphasized above, each of the one or more mixing assemblies 16 are structured to independently establish a predetermined coordinated mixture and/or ratio of gaseous and distillate fuels, which in turn define the operative fuel mixture for each combustion section 24 and more specifically for each of the combustion chambers 24′. As indicated, the supply of gaseous fuel is maintained at a positive pressure and delivered from the fuel supply 21 to the throttle body 18 and eventually from the throttle body 18 to the corresponding, integrated air gas mixer 20 at such positive pressure. Therefore, the gaseous fuel supply, throttle body 18 and integrated air gas mixer 20 are cooperatively structured and collectively operative to deliver gaseous fuel in appropriate, variable quantities and under a positive pressure to the intake air of the combustion section 24 of the engine.

Therefore, in the additional preferred embodiment of FIG. 3, a plurality of mixing assemblies 16 each include an integrated throttle body 18 and air gas mixer 20. As a result, each of the various cylinders 24′ of the combustion section 24 may have a different, variable ratio of gaseous and distillate fuels delivered thereto. Accordingly, an effectively different operative fuel mixture may be consumed in the different combustion chambers 24′. It is also emphasized that the ECU 12 and the one or more input data channels 14 are structured to continuously and repetitively monitor the predetermined engine data which in turn is determinative of the specific and/or range or ratios of distillate and gaseous fuels present in the mixture of the operative fuel mixture being delivered to each of the chambers 24′.

Accordingly, each of the plurality of mixing assemblies 16 comprises the integrated throttle body and air gas mixer 18 and 20 respectively. Further, each of the throttle bodies 18 is independently connected in gaseous fuel receiving relation to a common and/or separate fuel supply 21. As also represented, each of the air gas mixers 20 is disposed in fluid communication with a different flow path 22 and the intake air 22′ associated therewith. Further, the integrated structure of each of the mixing assemblies 16 include a throttle body 18 fixedly mounted on and/or connected to an exterior of a corresponding housing 26 of the associated, integrated air gas mixer 20. Similarly, each of the air gas mixers 20 includes a delivery nozzle 30 receiving gaseous fuel from a corresponding, integrated throttle body 18 through a delivery conduit 40. As such, each of the delivery conduits 40 is disposed within the interior 28 the housing 26 of corresponding ones of the air gas mixers 20.

With further regard to both FIGS. 2 and 3, dependent on the intended operation and structure of the engine with which the system of the present invention is utilized, a turbocharger 50 may be disposed within or along the flow path 22 of intake air 22′ so as to further process the intake air 22′ prior to being delivered to the combustion section 24 and/or individual cylinders 24′. In the embodiment of FIG. 2, a single turbocharger 50 is located between the mixing assembly 16 and the combustion section 24, such that the mixing assembly 16, including the integrated throttle body 18 and air gas mixer 20 is upstream along the flow path 22 of intake air 22′ being delivered to the combustion section 24.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A system operative to establish a coordinated mixture of gaseous and distillate fuels for an engine, said system comprising:
an electronic control unit (ECU) operative to monitor predetermined engine data determinative of engine fuel requirements,
said ECU structured to regulate ratios of the gaseous and distillate fuels of an operative fuel mixture for powering the engine at least partially based on the monitored engine data,
a gaseous fuel supply structured to retain and dispose the gaseous fuel under a positive pressure,
at least one mixing assembly comprising an integrated throttle body and air-gas mixer,
said throttle body disposed in fluid communication with said gaseous fuel supply and said air-gas mixer disposed in fluid communication with intake air to a combustion section of the engine, and
said throttle body structured to direct a variable gaseous fuel flow directly to said air gas mixer and the intake air to the combustion section.

2. A system as recited in claim 1 wherein said integrated throttle body and air-gas mixer comprise said throttle body fixedly mounted on said air-gas mixer.

3. A system as recited in claim 2 wherein said throttle body is fixedly connected on an exterior of said air-gas mixer; said air-gas mixer including an interior dispensing nozzle disposed within a flow path of the intake air.

4. A system as recited in claim 3 further comprising a delivery conduit disposed on an interior of said air gas mixer in interconnecting, gaseous fuel delivering relation between said throttle body and said dispensing nozzle; said delivery conduit and said gaseous fuel supply cooperatively structured to deliver gaseous fuel under a positive pressure from said throttle body to said air gas mixer.

5. A system as recited in claim 2 wherein said air-gas mixer comprises a housing at least partially disposed within and at least partially defining the flow path of the intake air.

6. A system as recited in claim 5 wherein said throttle body is fixedly mounted on an exterior of said housing; a delivery conduit disposed on an interior of said housing; said throttle body, said conduit and said gaseous fuel supply cooperatively structured to deliver gaseous fuel under a positive pressure from said throttle body to said air gas mixer.

7. A system as recited in claim 1 wherein said throttle body and said gaseous fuel supply are cooperatively structured to direct the variable gaseous fuel flow to said air mixer substantially at said positive pressure.

8. A system as recited in claim 7 wherein said positive predetermined pressure is generally about 3 psi to 7 psi.

9. A system as recited in claim 1 further comprising a turbocharger disposed within a flow path of the intake air to the combustion chamber; said integrated throttle body and air gas mixer disposed in fluid communication with the flow path upstream of said turbocharger.

10. A system as recited in claim 9 wherein said air-gas mixer comprises a housing at least partially disposed within and at least partially defining the flow path of the intake air.

11. A system as recited in claim 10 wherein said throttle body is fixedly mounted on an exterior of said housing; a delivery conduit disposed on an interior of said housing and structured to deliver gaseous fuel from said throttle body to said dispensing nozzle.

12. A system as recited in claim 9 wherein said turbocharger is disposed along said flow path in receiving relation to a mixture of air and gaseous fuel and in delivering relation to the combustion section of the engine.

13. A system operative to establish a coordinated mixture of gaseous and distillate fuels for an engine, said system comprising:
an electronic control unit (ECU) structured to monitor predetermined engine data determinative of engine fuel requirements,
said ECU operative to regulate ratios of the gaseous and distillate fuels of an operative fuel mixture to power the engine at least partially based on the monitored predetermined engine data,
a gaseous fuel supply structured to retain and dispense the gaseous fuel,
a plurality of mixing assemblies each comprising an integrated throttle body and air gas mixer,
each of said throttle bodies independently connected in gaseous fuel receiving relation to said gaseous fuel supply,
each of said air gas mixers disposed in fluid communication with a different flow path of intake air to a combustion section of the engine, and
each of said throttle bodies independently operable to direct a different, variable gaseous fuel flow to a corresponding, integrated air gas mixer and a corresponding one of the different flow paths of intake air.

14. A system as recited in claim 13 wherein each of said plurality of mixing assemblies include said throttle body fixedly mounted on a corresponding, integrated air gas mixer.

15. A system as recited in claim 13 wherein each of said air gas mixers comprises a housing at least partially disposed within and defining a corresponding one of the different flow paths of intake air; each of said throttle bodies fixedly mounted on an exterior of said housing of a corresponding integrated air gas mixer.

16. A system as recited in claim 13 wherein each of said throttle bodies and said gaseous fuel supply are cooperatively structured to direct the variable gaseous fuel flow to a corresponding, integrated one of said air-gas mixers substantially at a positive pressure.

17. A system as recited in claim 16 wherein said positive pressure is generally about 3 psi to 7 psi.

18. A system as recited in claim 13 further comprising a plurality of turbo chargers each disposed within a different one of the flow paths of the intake air to the combustion section; each of said integrated throttle bodies and air gas mixers disposed in fluid communication with the corresponding flow path of intake air, upstream of said turbo charger.

19. A system operative to establish a coordinated mixture of gaseous and distillate fuels for an engine, said system comprising:
an electronic control unit (ECU) structured to monitor predetermined engine data determinative of engine fuel requirements,
said ECU operative to regulate ratios of the gaseous and distillate fuels of an operative fuel mixture to power the engine at least partially based on the monitored predetermined engine data,
a gaseous fuel supply structured to retain and dispense the gaseous fuel under a positive pressure,
a plurality of mixing assemblies each comprising an integrated throttle body and air gas mixer,
each of said throttle bodies independently connected to said gaseous fuel supply in receiving relation to a positive pressure flow of gaseous fuel,
each of said air gas mixers disposed in fluid communication with a different flow path of intake air to a combustion section of the engine, and
each of said throttle bodies independently operable to direct a different, variable gaseous fuel flow under positive pressure directly to a corresponding, integrated air gas mixer and a corresponding one of the different flow paths of intake air.

20. A system as recited in claim 19 wherein each of said throttle bodies is fixedly mounted on an exterior of a corresponding integrated one of said air gas mixers; each of said throttle bodies and said gaseous fuel supply cooperatively structured to deliver gaseous fuel under a positive pressure from each of said throttle bodies to a corresponding, integrated one of said air gas mixers.
